(19) United States
(12) Patent Application Publication
(10) Pub. No.: US 2017/0249657 A1
(43) Pub. Date: Aug. 31, 2017

(54) CLIENT ENGAGEMENT AND LOYALTY PLATFORM

(71) Applicant: National Concessions Group Inc., Denver, CO (US)

(72) Inventor: Jeremy Heidl, Denver, CO (US)

(21) Appl. No.: 15/445,947

(22) Filed: Feb. 28, 2017

Related U.S. Application Data
(60) Provisional application No. 62/301,620, filed on Feb. 29, 2016.

(51) Int. Cl. G06Q 30/02

(52) U.S. Cl. CPC G06Q 30/0233; G06Q 30/0255

(57) ABSTRACT

A client engagement and loyalty platform is provided. The client engagement and loyalty platform may receive, at a communication device, an order summary identifying a plurality of items, wherein the order summary is associated with a user account. The client engagement and loyalty platform may also receive, at the communication device, identification information, the identification information including one or more identifiers associated with a retail establishment. The client engagement and loyalty platform may also associate, based on the one or more identifiers of the retail establishment and the order summary, a plurality of reward points with the user account. The reward points can be redeemed to purchase merchandise and/or services.

### CROSS REFERENCE TO RELATED APPLICATION

The present application claims the benefits of and priority, under 35 U.S.C. §119(e), to U.S. Provisional Application Ser. No. 62/301,620, filed Feb. 29, 2016, entitled “CLIENT ENGAGEMENT AND LOYALTY PLATFORM,” which is incorporated herein by reference in its entirety for all that it teaches and for all purposes.

### FIELD

The present disclosure generally relates to a client engagement and loyalty system. More specifically, the present disclosure provides unique methods and systems for providing a technology-driven platform that incentivizes marketplace transactions at every level of interaction.

### BACKGROUND

In recent years, and particularly as competition for similar and not-so similar products has increased, there has become a need to increase sales with respect to one or more products. Current methods of increasing sales of a particular product have often involved providing coupons, free samples, and/or discounting such a product. Often, however, a wholesaler, distributor, and/or manufacturer has little influence, other than price and quality, in increasing sales of a specific product when such manufacturer, distributor, and/or wholesaler does not sell to end consumers and/or when consumer sales make up a small portion of the manufacturer, distributor, and/or wholesaler total sales. Moreover, wholesalers, distributors, and manufacturers often have little control of increasing sales of a particular product at a particular time. Rather, wholesalers, distributors, and manufacturers often rely on retailers and channel partners to market and sell to end consumers.

### SUMMARY

It is an object of the present disclosure to provide a technology-driven platform that incentivizes marketplace transactions at every level of interaction. From the consumer, to the retailer, to the management at a wholesaler and/or manufacturer, this technology-driven platform revolutionizes loyalty, purchasing, and data aggregation. In accordance with embodiments of the present disclosure, the platform validates purchases, or other redemption incentives, using, for example, a physical mechanism, such as a state-of-the-art stamping mechanism. Accordingly, consumers receive awards, such as points, for their purchases and loyalty, and have the opportunity to attain one of many distinct loyalty levels once certain milestones, such as an accumulated amount of points, is reached. Rewards within these levels may include personalized gear, exclusive event access, an opportunity to test new products before the general public, and much more. Accordingly, by allowing the wholesaler, distributor, and/or manufacturer to exert some control over such a system, the wholesaler, distributor, and/or manufacturer may directly influence sales of a specific product to move and/or retain product inventory, or more generally, exert some control over consumer sales.

In embodiments, a mobile and web-based loyalty platform designed to grow and retain existing customers through incentives is disclosed. The system (web-based loyalty platform) monitors and validates transactions by customers to enable them to earn points that can be redeemed for loyalty rewards. The system additionally monitors the activity of sales channel representatives and incentivizes them for referring the brand and facilitating customer transactions. Such a system may enable rewards for the sales channels and additionally provide real-time reporting of sales activity across geographical markets and retail locations. In accordance with embodiments of the present disclosure, a system may reward users for the following non-limiting examples: transactions of brand product; sharing brand content; and referring other users to adopt a platform with dual-sided incentives. In accordance with embodiments of the present disclosure, the system utilizes the following non-limiting methods to achieve various objectives: geolocation of brand product availability at participating retailers; purchase verification using touchscreen sensor stamps and/or QR (quick response) code scanning; and geofencing to validate transactions with location-aware devices.

In accordance with embodiments of the present disclosure, a method is provided, the method includes receiving, at a communication device, an order summary identifying a plurality of items, wherein the order summary is associated with a user account, receiving, at the communication device, identification information including one or more identifiers associated with a retail establishment, and associating, based on the one or more identifiers of the retail establishment and the order summary, a plurality of reward points with the user account.

In accordance with embodiments of the present disclosure, a method is provided, the method includes identifying a plurality of user accounts based on purchase history information in each of the user accounts that is associated with a retail establishment, wherein the purchase history information includes a specified item purchased at the retail establishment, generating an advertisement based on the specified item and the retail establishment, and providing the advertisement to one or more users associated with the plurality of user accounts.

In accordance with embodiments of the present disclosure a client engagement and loyalty platform is provided, the platform including a database including a consumer profile and a retail establishment profile, one or more instructions residing in a memory that, when executed by a processor of a communication device, cause the communication device to receive an order summary identifying a plurality of items, determine identification information including one or more identifiers associated with a retail establishment in the retail establishment profile, associate a first plurality of reward points with the consumer in the consumer profile, and associate a second plurality of reward points with the retail establishment in the retail establishment profile.

### BRIEF DESCRIPTION OF THE DRAWINGS

The accompanying drawings, which are incorporated in and constitute a part of the specification, illustrate embodiments of the disclosed system and, together with the general description of the disclosure given above and the detailed description of the drawings given below, serve to explain the principles of the disclosure.

FIG. 1 illustrates a first block diagram of a client engagement and loyalty system in accordance with embodiments of the present disclosure;

FIG. 2 illustrates additional details of a portion of the first block diagram of the client engagement and loyalty system in accordance with embodiments of the present disclosure;

FIG. 3 illustrates a first block diagram of a communication device in accordance with embodiments of the present disclosure;

FIG. 4 illustrates a first block diagram of a server in accordance with embodiments of the present disclosure;

FIG. 5 illustrates details of one or more profiles in accordance with embodiments of the present disclosure;

FIGS. 6A-6F illustrate a mobile application in accordance with embodiments of the present disclosure;

FIG. 7A-B illustrate a stamping process in accordance with embodiments of the present disclosure; and

FIG. 8 illustrates one or more designs and a matching process in accordance with embodiments of the present disclosure;

FIG. 9 illustrates reading and/or imaging a matrix barcode, or QR image in accordance with embodiments of the present disclosure;

FIG. 10A-10B illustrate a verification process in accordance with embodiments of the present disclosure;

FIG. 11A-11B illustrate a redemption of one or more special offers in accordance with embodiments of the present disclosure;

FIG. 12 illustrates a first flow chart in accordance with embodiments of the present disclosure;

FIG. 13 illustrates a second flow chart in accordance with embodiments of the present disclosure;

FIG. 14 illustrates a third flow chart in accordance with embodiments of the present disclosure; and

FIG. 15 illustrates a fourth flow chart in accordance with embodiments of the present disclosure.

In certain instances, details that are not necessary for an understanding of the disclosure or that render other details difficult to perceive may have been omitted. It should be understood, of course, that the disclosure is not necessarily limited to the particular system embodiments illustrated herein.

### DETAILED DESCRIPTION

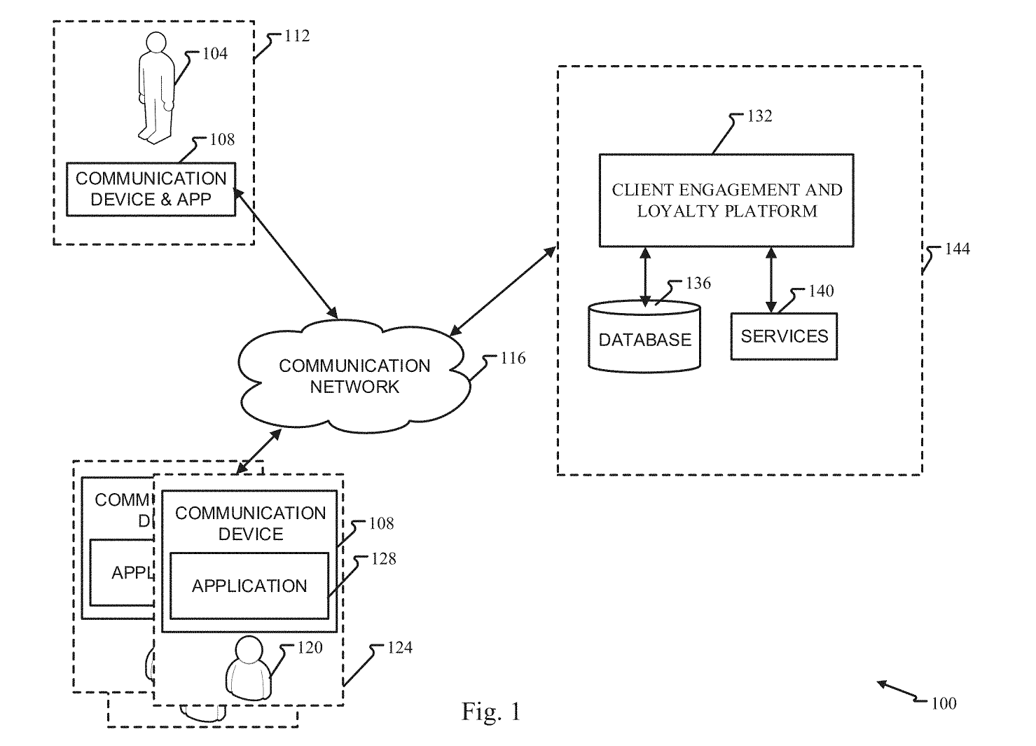

Referring initially to FIG. 1, a client engagement and loyalty system 100 is illustrated in accordance with at least one embodiment of the present disclosure. The client engagement and loyalty system 100 may allow a consumer 104 to participate in the client engagement and loyalty system 100 using a communication device 108 while at a retail location 112. Although the consumer 104 is depicted as being at a retail location 112, the consumer 104 may be at a location other than the retail location 112. In accordance with embodiments of the present disclosure, the consumer 104 may access a client engagement and loyalty platform 132 utilizing the communication network 116.

The communication network 116 may be packet-switched and/or circuit-switched. An illustrative communication network 116 includes, without limitation, a Wide Area Network (WAN), such as the Internet, a Local Area Network (LAN), a Personal Area Network (PAN), a Public Switched Telephone Network (PSTN), a Plain Old Telephone Service (POTS) network, a cellular communications network, an IP Multimedia Subsystem (IMS) network, a Voice over IP (VoIP) network, a SIP network, or combinations thereof. The Internet is an example of the communication network 116 that constitutes an Internet Protocol (IP) network including many computers, computing networks, and other communication devices located all over the world, which are connected through many telephone systems and other means. In one configuration, the communication network 116 is a public network supporting the TCP/IP suite of protocols. Communications supported by the communication network 116 include real-time, near-real-time, and non-real-time communications. For instance, the communication network 116 may support voice, video, text, web-conferencing, or any combination of media. Moreover, the communication network 116 may comprise a number of different communication media such as coaxial cable, copper cable/wire, fiber-optic cable, antennas for transmitting/receiving wireless messages, and combinations thereof. In addition, it can be appreciated that the communication network 116 need not be limited to any one network type, and instead may be comprised of a number of different networks and/or network types. It should be appreciated that the communication network 116 may be distributed. Although embodiments of the present disclosure will refer to one communication network 116, it should be appreciated that the embodiments claimed herein are not so limited. For instance, multiple communication network 116 may be joined by many servers and networks.

The communication device 108 may comprise any type of known communication equipment or collection of communication equipment. Examples of a suitable communication device 108 may include, but are not limited to, a personal computer and/or laptop with a telephony application, a cellular phone, a smart phone, a telephone, a tablet, or other device that can make or receive communications. In general, each communication device 108 may provide many capabilities to one or more users/consumers 108 who desire to interact with the client engagement and loyalty platform 132.

In accordance with embodiments of the present disclosure, the client engagement and loyalty platform 132 may reside within a server 144 and may further interact with a database 136 and/or a services module 140. The database 136 may include information pertaining to the consumer 104, wholesaler, distributor, and/or manufacturer while the services module 140 may allow access to such information in the database 136. In some instances, data in the database 136 may be accessed utilizing one or more service modules 140 and an application 128 running on a communication device, such as communication device 108, and at a location 124 different from the location 112. Accordingly, a user 120, which may be the same as or different from the consumer 104, may access such information. As one non-limiting example, the user 120 may be at least one of a retailer, wholesaler, distributor. In some instances, the user 120 may be a consumer. Thus, any one of the retailer, wholesaler, distributor, and/or consumer may view awarded incentives, sales-related information, and/or performance data related to one or more products or services. Such products or services may be provided by any one of the retailer, wholesaler, and/or distributor. Although FIG. 1 depicts a single database 136 and a single service module 140, it should be appreciated that one or more servers 144 may include one or more services module 140 and one or more databases 136.

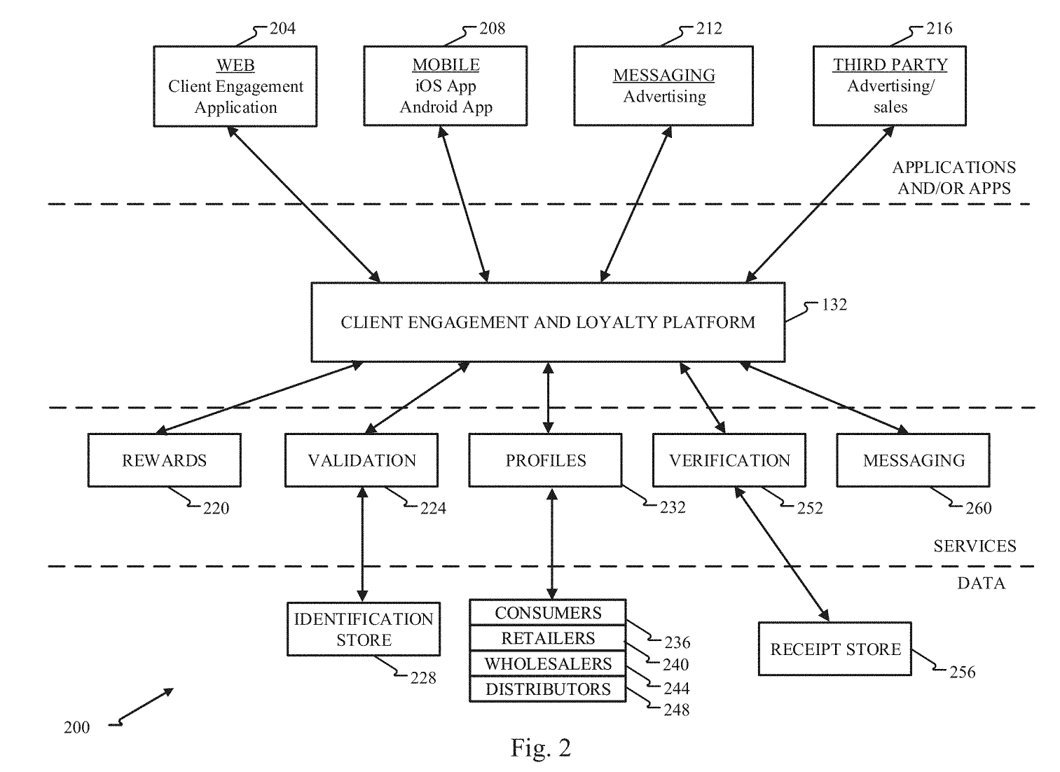

FIG. 2 depicts a hierarchical system diagram 200 in accordance with at least one embodiment of the client engagement and loyalty system 100. The system 200 depicts the interaction of the application 128 and/or the app executed by the communication device 108 and the client engagement and loyalty platform 132. FIG. 2 further illustrates the interaction between the services 140 and the client engagement and loyalty platform 132, as well as the interaction between the data in the database 136, the services module 140, and the client engagement and loyalty platform 132. In accordance with embodiments of the present disclosure, the data stored within the database 136 may include, but is not limited to, reward information, an identification store 228 for storing identification information utilized in a validation process, consumer(s) profile 236, retailer(s) profile 240, wholesaler(s) profile 244, distributor(s) profile 248, a receipt information in the receipt store 256, and additional information, such as grouping information utilized when sending and/or otherwise pushing messages to one or more consumers 104 utilizing one or more communication devices 108. In accordance with embodiments of the present disclosure, the client engagement and loyalty system 100 may rely on one or more services to access such data and provide such data to the client engagement and loyalty platform 132. Accordingly, a consumer 104 may utilize the client engagement application 204 and/or mobile application 208 to access and/or provide data to the database 136.

For example, a consumer 104 may utilize a mobile app 208 executing on a communication device 108 to indicate, or otherwise identify, items purchased at a retail location. Such data may be received at the client engagement and loyalty platform 132 and associated with a consumer profile 236 belonging to or otherwise associated with the consumer 104. Alternatively, or in addition, the client engagement and loyalty platform 132 may receive an indication that indicates a particular identifier belonging to a retailer and/or a wholesaler has been used; such use may be associated with the retailer(s) profile 240 and/or the wholesaler(s) profile 244. As will be described, the indication indicating that a particular identifier has been used may be first received at the communication device 108 and then received at the client engagement and loyalty platform 132, causing a validation service 224 to compare the received indication to one or identifications residing in the identification store 228. Once the indication has been validly identified, one or more rewards service 220 may assign a reward, such as reward points, to a consumer profile 236. In some instances, and prior to the assigning of a reward, a verification service 252 may be invoked as a second means to verify that the consumer 104, for instance, validly purchased such previously indicated, or otherwise identified, items. As one example, the consumer 104 may be asked to take a picture of a purchase receipt and upload such receipt using the mobile application 208 and/or the client engagement application 204. The receipt may then reside in a receipt store 256 until such previously identified items are reconciled with such items on the receipt. Such reconciliation may be performed by the verification service 252 in an automated and/or manual manner. For example, an optical character recognition process may be invoked to identify characters on the receipt and further match such characters and/or words to the previously indicated items. After successful reconciliation, the rewards service 220 may assign appropriate rewards to one or more of the profiles 236-248. Thus, not only is the consumer 104 rewarded, but a retailer, wholesaler, and/or distributor may be rewarded as well.

In accordance with embodiments of the present disclosure, a messaging service 260 may be utilized to push and/or send SMS messages to a communication device 108 of a consumer 104. Such message may indicate an item is on sale, indicate an item is on sale for a limited amount of time, provide a status of awards associated with a consumer profile 236, and/or provide other product and/or item related information. One or more consumers 104 may be grouped based on a previous purchase history or other information residing within their profile 236. Thus, the messaging application 212, as a standalone application or as part of the client engagement application 204 and/or mobile application 208, may be utilized to find, filter, and group those consumers 104 which may have been determined to benefit from a current award and/or item/product offering and/or sale and/or have been determined to be most likely to participate in such a sale. Further still, retailers, wholesalers, and/or distributors may be grouped and messages may be provided to such in a similar manner. Thus, such messages and/or advertisements may provide a method for retailers, wholesalers, and/or distributors to manage inventory. For example, if a retailer would like to notify consumers 104 that a particular item is on sale in order to make room for inventory of another item/product, the retailer may provide such messages to one or more consumers 104. Alternatively, or in addition, a manufacturer, distributor, and/or wholesaler may provide such messages to those consumers 104 that are frequent purchasers of a particular item/product in order to increase demand, cause reorders, and/or move inventory. By doing such, inventory of a targeted item/product may move faster than other items/products.

Moreover, by using the client engagement and loyalty platform 132, one or more of the manufacturer, distributor, and/or retailer may gain insight into which items/products are more popular than others. Accordingly, supply for such items can be better anticipated, lead times may be reduced, inventory can be better managed, and advertising campaigns can be more accurately tailored based on such information. Further, because purchases may be recorded and otherwise tracked utilizing the client engagement and loyalty platform 132, appropriate incentives and/or awards may be provided to target consumers and/or entities. For example, a consumer 104 may accumulate points and may redeem such points for free merchandise. At a retailer level, the retailer may accumulate points and/or rewards based on tracked interactions with consumers 104 and/or sales of the items/products. Thus, such points and/or rewards may then be used by the retailer for free merchandise, free advertising, pushed advertisements, and/or other favorable rewards and terms for the retailer. As one example, when a retailer achieves a certain number of valid transactions and/or sales (for example, monetary, by volume, or otherwise), a manufacturer, distributor, and/or wholesaler may reward the retailer with free advertising using the client engagement and loyalty platform 132. Accordingly, the manufacturer, distributor, and/or wholesaler may push advertisements to one or more of the communication devices 108 of the consumer 104, where the advertisement is specifically targeted to the particular retailer or retail location. The client engagement and loyalty platform 132 provides the ability for an entity to view and incentivize market place transactions for those transactions occurring at a step(s) below the entity. For example, the retailer may be able to incentivize a consumer and view transactions relating to the consumer. The wholesaler may be able to incentivize a consumer and retailer and view transactions relating to the consumer and retailer. The distributor may be able to incentivize a consumer, retailer, and wholesaler and view transactions relating to the consumer, retailer, and wholesaler. The manufacturer may be able to incentivize a consumer, retailer, wholesaler, and distributor and view transactions relating to the consumer, retailer, wholesaler, and distributor.

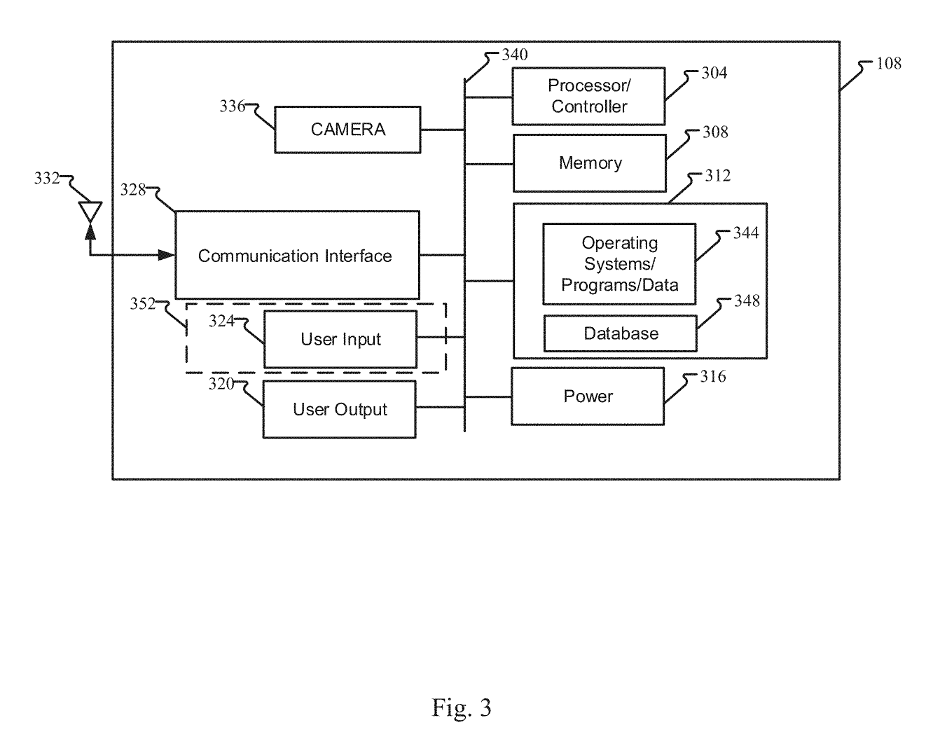

FIG. 3 depicts an example communication device 108 in accordance with embodiments of the present disclosure. The communication device 108 may include a processor/controller 304 capable of executing program instructions. The processor/controller 304 may include any general-purpose programmable processor or controller for executing application programming. Alternatively, or in addition, the processor/controller 304 may comprise an application specific integrated circuit (ASIC). The processor/controller 304 generally functions to execute programming code that implements various functions performed by the communication device 108. The processor/controller 304 of one or more of the communication device 108 may operate to execute one or more computer-executable instructions of the client engagement application 204 and/or the mobile application 208 for example. Alternatively, or in addition, the processor/controller 304 may operate to execute one or more computer-executable instructions of one or more services and/or one or more functions associated with the data.

The communication device 108 additionally includes memory 308. The memory 308 may be used in connection with the execution of programming instructions by the processor/controller 304, and for the temporary or long-term storage of data and/or program instructions. The memory 308 may comprise solid-state memory that is resident, removable, and/or remote in nature, such as DRAM and SDRAM. Moreover, the memory 308 may include a plurality of discrete components of different types and/or a plurality of logical partitions. In accordance with still other embodiments, the memory comprises a non-transitory computer-readable storage medium. Such a medium may take many forms, including, but not limited to, non-volatile media, volatile media, and transmission media.

The communication device 108 may include storage 312 for storing an operating system, one or more programs 344, and additional data in the database 348. The storage 312 may be the same as or different from the memory 308. For example, the storage 312 of the communication device 108 may include the database 348 for storing data used by the communication device 108.

In addition, user input devices 324 and user output devices 320 may be provided and used in connection with the communication device 108. For example, a consumer 104 may enter items purchased at a retailer in the mobile application 208 and have such a purchase validated. The validation procedure may utilize a stamp that is specific to the retailer and/or an associate of the retailer, where the stamp contacts a touchscreen 352 of the communication device 108 such that characteristics identifying the stamp can be discerned and an identification of the stamp can be made. Other examples of user input devices 324 include a keyboard, a numeric keypad, a microphone, scanner, and pointing device combined with a screen or other position encoder. Examples of user output devices 320 include a display, a touch screen display, a speaker, and a printer. Further, user output devices 320 may provide one or more interfaces for user interfacing.

The communication device 108 generally includes a communication interface 328 to allow for communication between communication devices, such as communication devices 108, and the client engagement and loyalty platform 132. The communication interface 328 may support 3G, 4G, cellular, WiFi, Bluetooth®, NFC, RS232, RF, Ethernet, one or more communication protocols, and the like. In some instances, the communication interface 328 may be connected with an antenna 332. Alternatively, or in addition, the communication interface 328 may be connected to one or more mediums for accessing the communication network 116.

The communication device 108 may include at least one imaging device, such as a camera 336. The camera 336 may allow a user 104 of the communication device 108 to capture images, such as a QR image used in a validation procedure as previously discussed and further as will be discussed. Moreover, one or more cameras 336 may be utilized to capture images of a receipt used in a verification procedure as will be discussed. Communications between various components of the communication device 108 may be carried by one or more buses 340. Moreover, power 316 can be supplied to the components of the communication device 108. The power 316 may, for example, include a battery, an AC to DC converter, power control logic, and/or ports for interconnecting the communication device 108 to an external source of power.

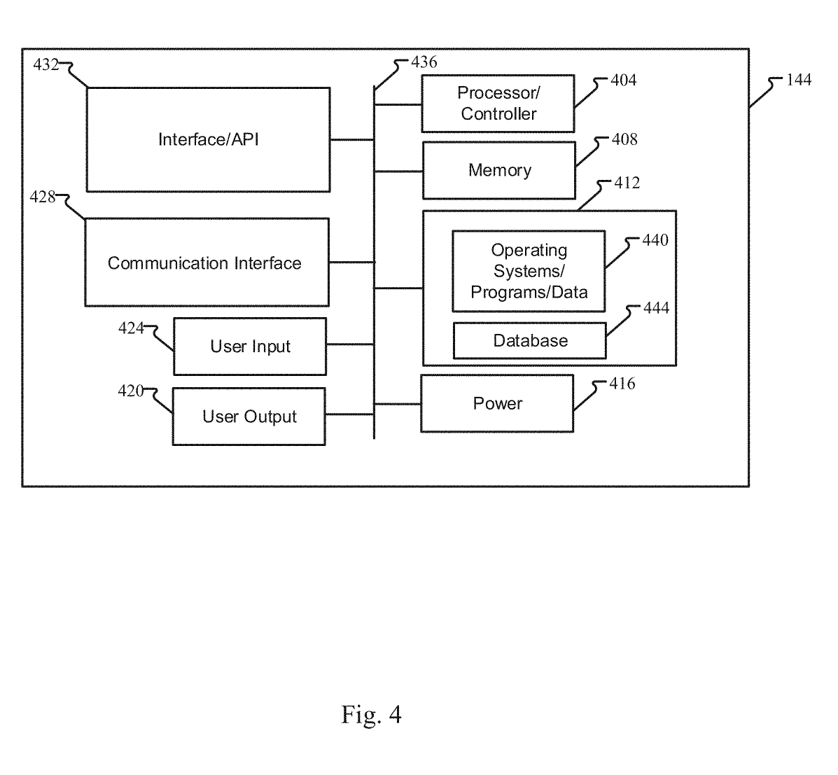

FIG. 4 depicts additional details of one or more servers 144 implementing the client engagement and loyalty platform 132 in accordance with embodiments of the present disclosure. Similar to the communication device 108, the server 144 may include a processor/controller 404 capable of executing program instructions. The processor/controller 404 may be the same as or similar to the processor/controller 304, and therefore may include any general-purpose programmable processor or controller for executing application programming. Alternatively, or in addition, the processor/controller 404 may comprise an application specific integrated circuit (ASIC). The processor/controller 404 generally functions to execute programming code that implements various functions performed by the server 144 and the client engagement and loyalty platform 132. The processor/controller 404 of one or more of the server 144 may operate to execute one or more computer-executable instructions of the client engagement and loyalty platform 132 as will be described herein. Alternatively, or in addition, the processor/controller 404 of one or more of the client engagement and loyalty platform 132 may operate to execute one or more computer-executable instructions of one or more services module 140 and/or one or more functions associated with the data and database 136.

The server 144 additionally includes memory 408. The memory 408 may be used in connection with the execution of programming instructions by the processor/controller 404, and for the temporary or long-term storage of data and/or program instructions. For example, the processor/controller 404, in conjunction with the memory 408 of the server 144, may implement one or more modules, web services, APIs and other functionality that is needed and accessed by a communication device, such as communication device 108. The memory 408 of the server 144 may comprise solid-state memory that is resident, removable, and/or remote in nature, such as DRAM and SDRAM. Moreover, the memory 408 may include a plurality of discrete components of different types and/or a plurality of logical partitions. In accordance with still other embodiments, the memory comprises a non-transitory computer-readable storage medium. Such a medium may take many forms, including, but not limited to, non-volatile media, volatile media, and transmission media.

The server 144 may include storage 412 for storing an operating system, one or more programs, and additional data 440. The storage 412 may be the same as or different from the memory 408. For example, the storage 412 of the server 144 may include a database 444 for storing data. Of course, the database 444 may be distributed across one or more servers 144.

In addition, user input devices 424 and user output devices 420 may be provided and used in connection with the server 144. Alternatively, or in addition, a first user may enter information, or initiate a communication with the client engagement and loyalty platform 132, by directing a web browser to a website served and/or provided by the server 144 by entering a website address or by clicking on a hyperlink associated with the website. Alternatively, or in addition, a user may enter information, or initiate a communication with the client engagement and loyalty platform 132, by interacting with a mobile application, such as the mobile application 208. Otherwise, a user may interact with the server 144 using user input devices 424 and user output devices 420. Examples of user input devices 424 include a keyboard, a numeric keypad, a touch screen, a microphone, scanner, and pointing device combined with a screen or other position encoder. Examples of user output devices 420 include a display, a touch screen display, a speaker, and a printer. Further, user output devices 420 may provide one or more interfaces for user interfacing.

The server 144 generally includes a communication interface 428 to allow for communication between communication devices, such as communication devices 108, and the client engagement and loyalty platform 132. The communication interface 428 may support 3G, 4G, cellular, WiFi, Bluetooth®, NFC, RS232, RF, Ethernet, one or more communication protocols, and the like. In some instances, the communication interface 428 may be connected to one or more mediums for accessing the communication network 116.

The server 144 may include an interface/API 432. Such interface/API 432 may include the necessary functionality to implement the client engagement and loyalty platform 132 or a portion thereof. Alternatively, or in addition, the interface/API 432 may include the necessary functionality to implement one or more services and/or one or more functions related to the data. Alternatively, or in addition, the interface/API 432 may include the necessary functionality to implement one or more of the client engagement application 204, mobile application 208, advertising and messaging application 212, and/or third party access applications 216 and/or portions thereof. Communications between various components of the server 144 may be carried by one or more buses 436. Moreover, power 416 can be supplied to the components of the server 144. The power 416 may, for example, include a battery, an AC to DC converter, power control logic, and/or ports for interconnecting the server 144 to an external source of power.

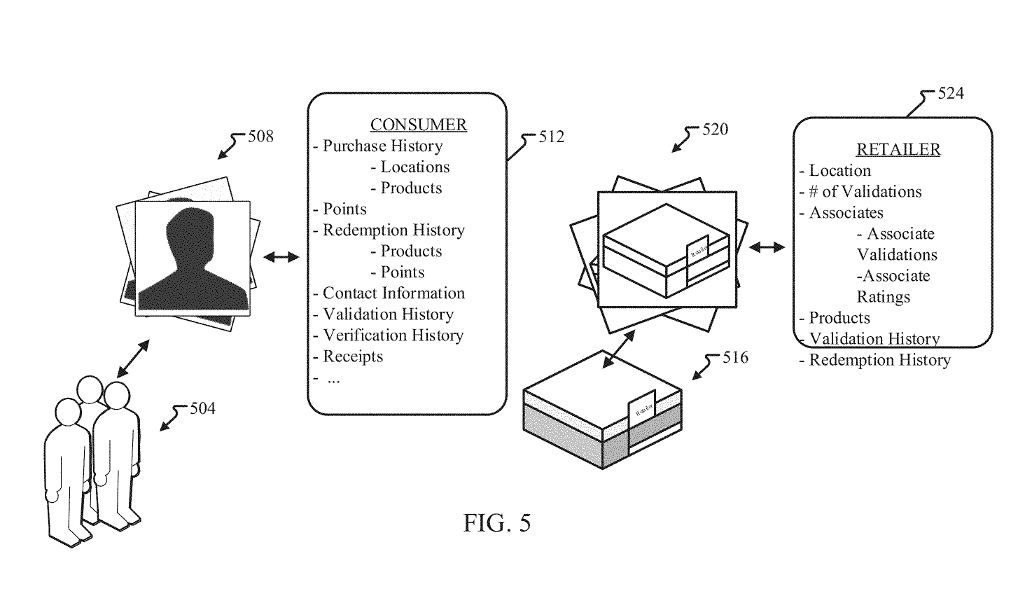

FIG. 5 generally depicts additional information that may be included in the consumer(s) profile 236 and retailer(s) profile 240 in accordance with embodiments of the present disclosure. As previously discussed, the consumer profile(s) 508 may be stored and maintained in one or more databases 136. Each of the consumer profile(s) 508, or consumer account, may include information directly and indirectly relating to the consumer. For example, the consumer profile(s) 508 may include a purchase history of the consumer: specifically, products purchased, the location where the products are purchased, and the date and time of such purchases may be included in the consumer profile(s) 508. Moreover, an amount of rewards, such as points, as well as a reward history may be included in the consumer profile(s) 508. Further, the redemption history associated with the consumer(s) 504 may be included in the consumer profile(s) 508: specifically, the products redeemed, the points redeemed for such products, and date and time of such redemptions may be included in the consumer profile(s) 508. In addition, a validation history including an identification and/or identifier associated with the validation may be included in the consumer profile(s) 508 such that retailers and associates of such retailers may be identified and linked to one or more purchases. Further, a verification history may be maintained in the consumer profile(s) 508, including one or more receipts. Lastly, the consumer profile(s) 508 may include contact information, such as email address, username, phone number, age, etc. related to the consumer(s) 504. Of course, the items described with respect to the consumer profile(s) 508 and illustrated in the user profile information 512 should not be interpreted as limiting the contents of the consumer profile(s) 508. The consumer profile(s) 508 may include more or less data and information directly and/or indirectly related to the consumer(s) 504.

FIG. 5 additionally depicts one or more retailer profile(s) 520, or retailer account, associated with one or more retailer(s) 516. Each of the retailer profile(s) 520 may include information directly and indirectly relating to a retailer. For example, the retailer profile(s) 520 may include a location of the retailer(s) 516, associates, management, or other employees associated with the retailer(s) 516, as well as one or more ratings associated with the associates, management, or other employees associated with the retailer(s) 516. For example, each employee of the retailer(s) 516 may include a rating or their own profile information including name and/or other identifying information, as well as a number validations performed by said associate and/or a rating grade (for example, 4 stars) for various levels of service. The retailer profile(s) 520 may further include indirect information relating to the retailer(s) 516; for example, the retailer profile(s) 520 may include information generally related to past, present, and future sales information for one or product, or many products. Additional information may include a pricing information for products, redemption history for the retailer(s) 516 (for example, redemptions related to advertising) as well as effects of advertising redemptions. For example, one may determine an effectiveness of an advertising campaign directed to one or more products of a manufacturer, distributor, or wholesaler based on sales information following such advertising campaign. Alternatively, or in addition, the information included in the retailer profile(s) 520 may include sourcing information, for example from which wholesaler, distributor, and/or manufacturer the retailer(s) 516 received one or more products. Of course, the items described with respect to the retailer profile(s) 520 and illustrated in the retailer profile information 524 should not be interpreted as limiting the contents of the retailer profile(s) 520. The retailer profile(s) 520 may include more or less data and information directly and/or indirectly related to the retailer(s) 516.

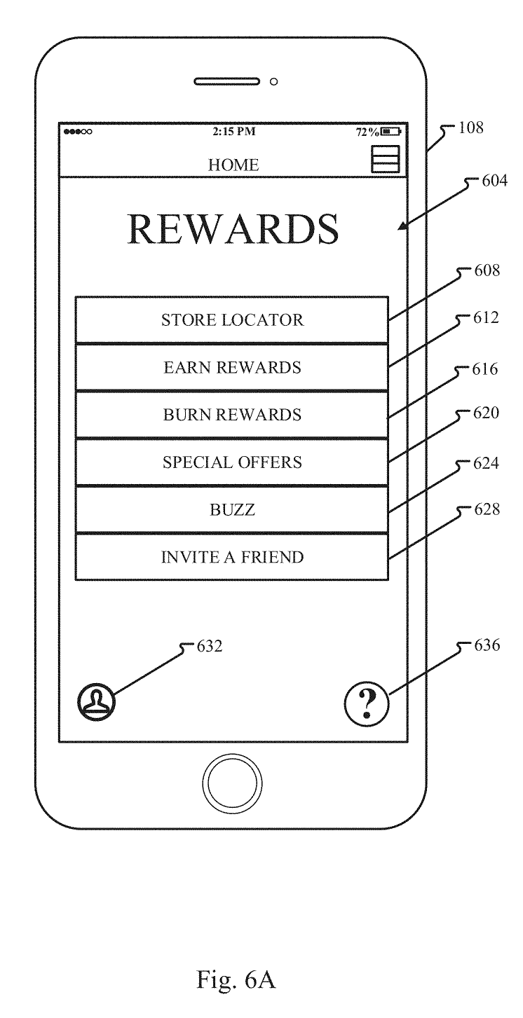

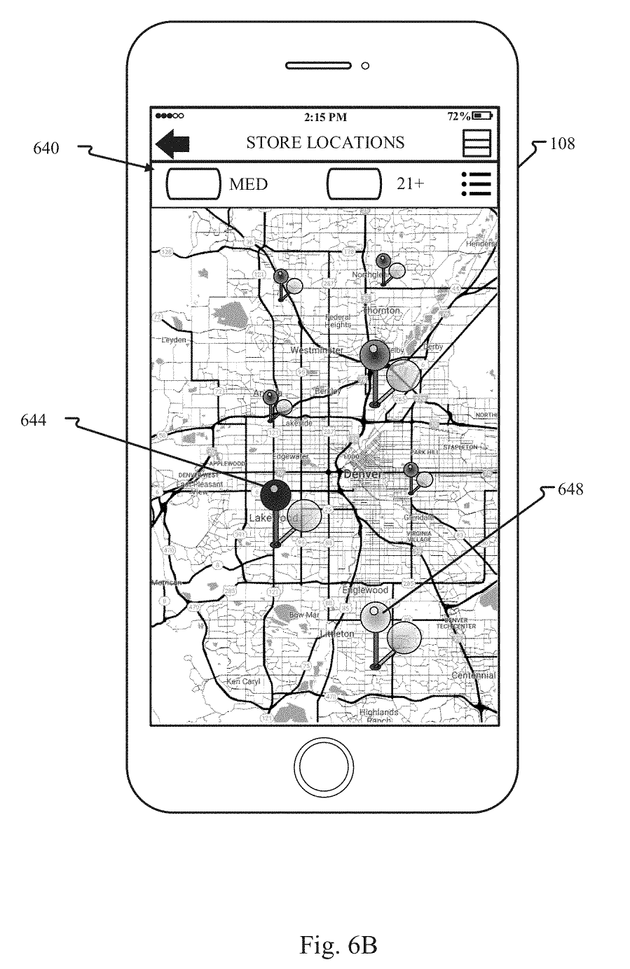

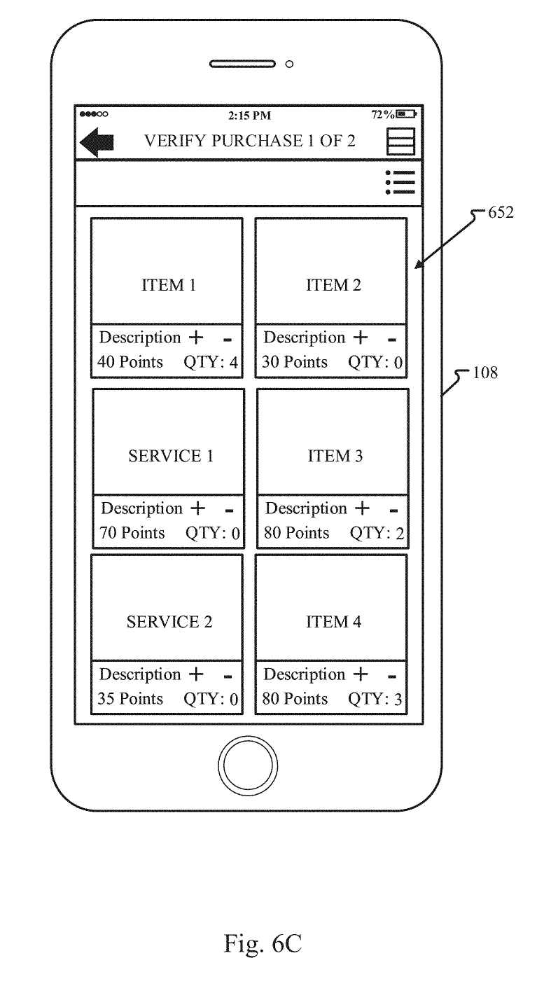

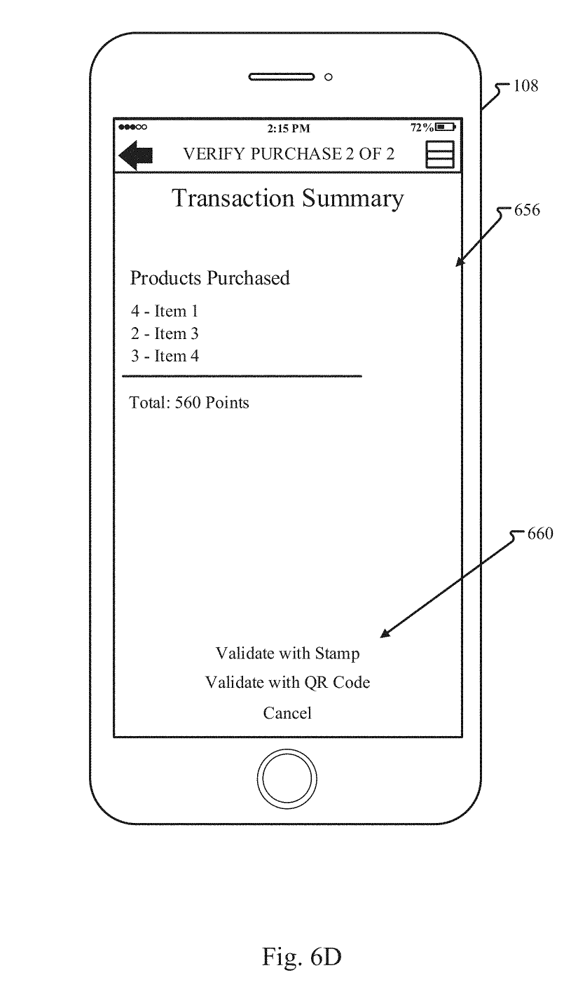

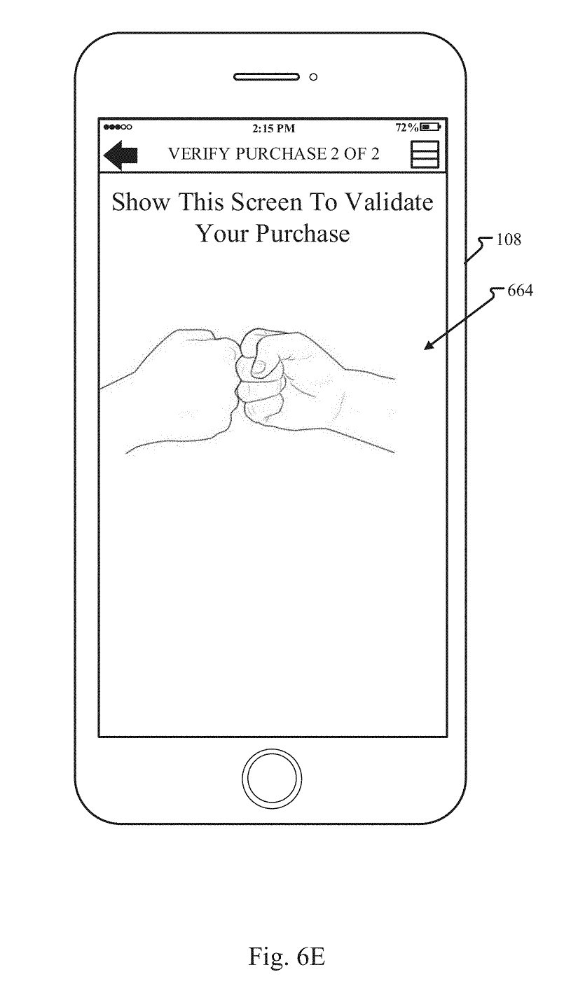

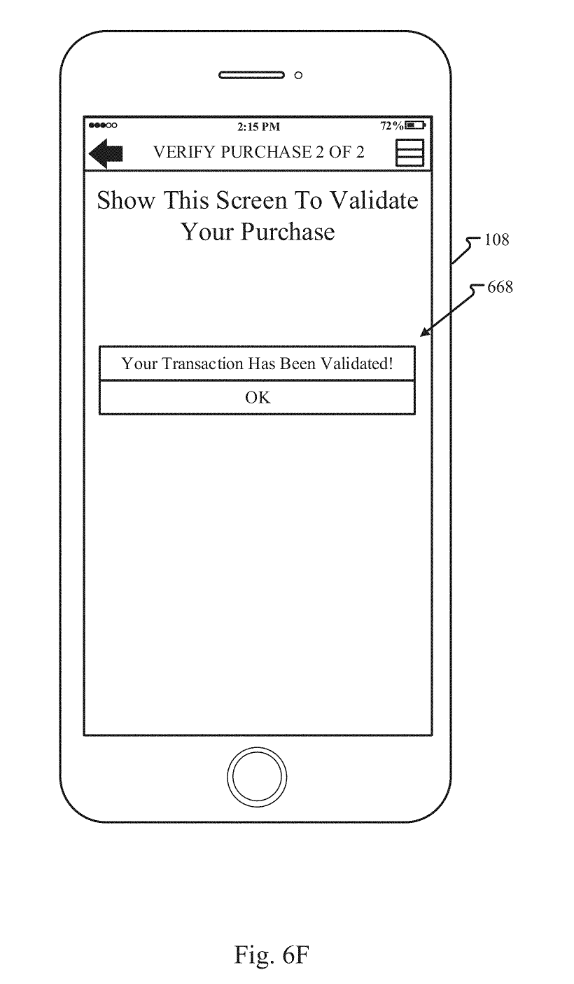

FIG. 6A depicts an example graphical user interface depicting a loyalty application 604 that is executed on a communication device 108. The loyalty application 604 may be the same as the mobile application 208 as previously discussed and may depict a first screen or display, such as a home screen, providing a user of the client engagement and loyalty platform 132 one or more navigation options in the loyalty application 604, that is executing on one or more devices. The loyalty application 604 may include a link and/or button 608 to a store locator to locate one or more stores, events, mobile kiosks etc. The loyalty application 604 may include a link and/or button 612 to an earn rewards screen where a user may complete a purchase/rewards verification process and earn points based on the user's purchase. The loyalty application 604 may include a link and/or button 616 to a burn rewards screen allowing a user to proceed through a redemption process, redeeming reward points for merchandise, services, events etc. The loyalty application 604 may include a link and/or button 620 to a special offers screen allowing a user to view special offers provided by a client/budtender/manufacturer etc. The loyalty application 604 may include a link and/or button 624 to a buzz screen allowing a user to participate in one or more social networking sites, provide product comments, merchandise comments, event comments etc. The loyalty application 604 may include a link and/or button 628 to an invite a friend screen allowing a user to invite friend or other user to the loyalty program platform. The loyalty application 604 may include a link and/or button 632 to a user profile editor screen allowing a user to edit a consumer profile(s) 508. The loyalty application 604 may include a link and/or button 636 to a help screen providing help to user.

As depicted in FIG. 6B, the loyalty application 604 may provide a store locator to locate one or more stores, events, mobile kiosks etc. in accordance with embodiments of the present disclosure. For example, the store locator may allow a consumer to locate one or more retail locations that carry and/or sell a particular product. One or more filters 640 may be applied to limit the results; that is, the “store locator” may also provide the ability to filter information based on one or more criteria. For example, a filter for medical products, strains, and devices may limit the resulting retail locations, as indicated by the pins 644 and 648. Moreover, the filter 640 may include the option to limit results to retail locations only selling to those of twenty-one years of age or older. Moreover, the pins may change color or otherwise be different from one another, for example in size, color, and/or shape, and may represent or otherwise identify retail stores, mobile kiosks, and/or events. For example, an event may be identified by pin 644 while a retail location is represented by pin 648, which depicts a screen, or display, such as a the “Store Locator” screen. Moreover, the store locator screen, or display, provides access to information associated with a store and/or location, such as hours, directions, and store types such as, but not limited to, medical or recreational licenses. Icons, differentiated by color, shape, size, etc. may indicate one or more parameters associated with each store or location. The “store locator” may further provide additional details with respect to events and may be further configured to receive push notifications that include promotional information such as advertisements, sales, etc.

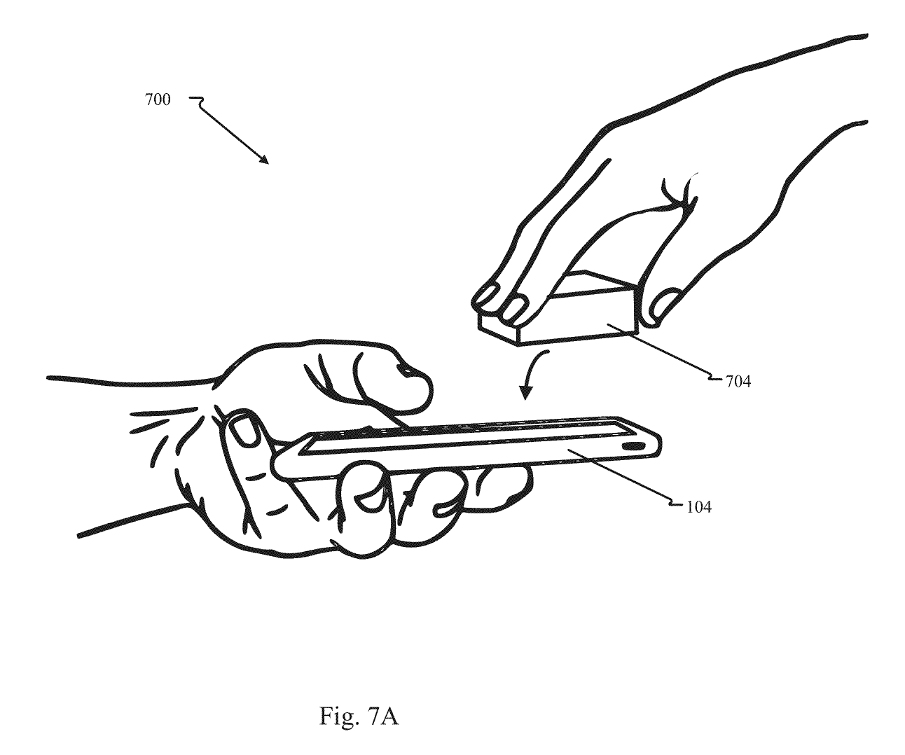

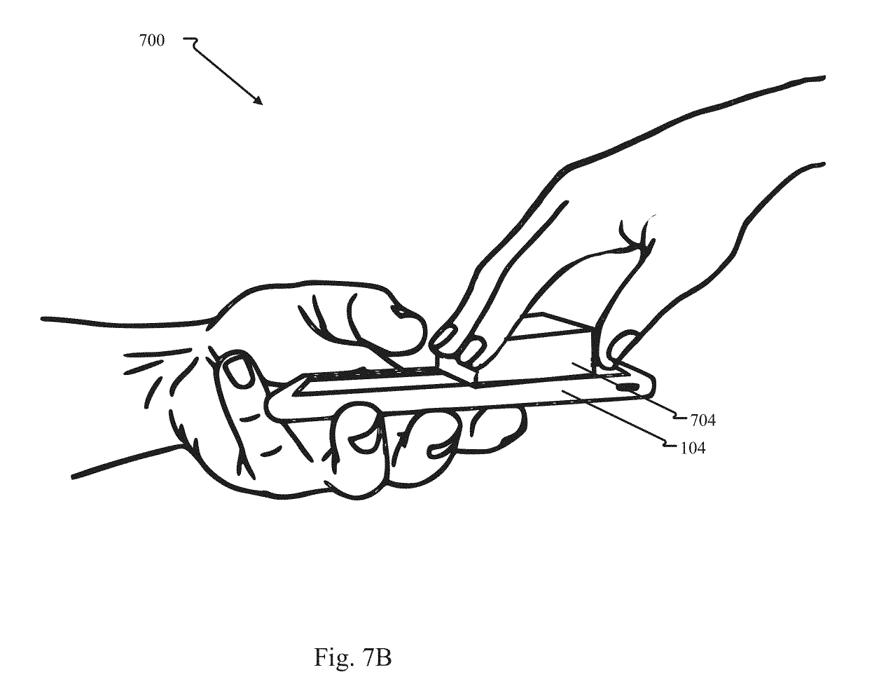

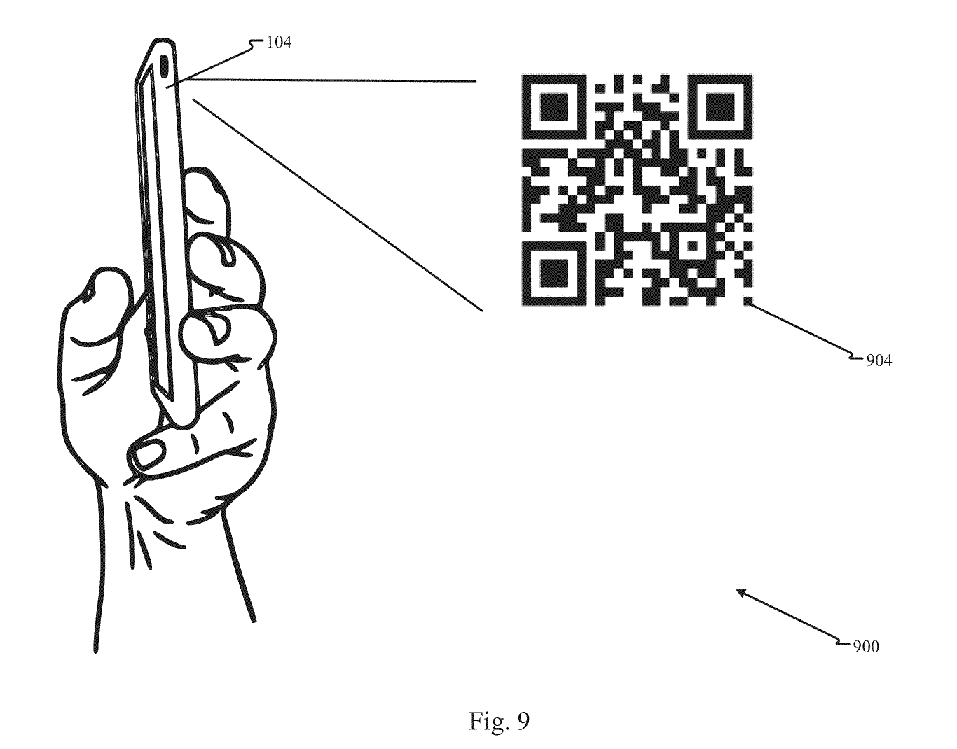

FIG. 6C depicts a first screen associated with an earn rewards screen where a user may complete a purchase/rewards verification process and earn points based on the user's purchase. As depicted in FIG. 6C, products that have been purchased, or products intended to be purchased are selected. As each product and/or quantity is selected, a total of reward points for each item may be displayed. A user may navigate to a summary screen, such as that which is displayed in FIG. 6D. That is, as depicted in FIG. 6D, a total of potential reward points may be displayed based on the previously selected products and quantities. Before reward points may be associated with a consumer 104, such as a consumer account and/or consumer profile(s) 508, the information displayed, such as that which displayed in FIG. 6D, must be validated. As another example, a consumer 104 may select one or more items and/or services 652 purchased and indicate a quantity of such purchased items and/or services 652. Each item and/or service 652 may include a reward value, such as a point value, a description of the item and/or service 652, and a picture of the item and/or service 652. Once the items and/or services 652 have been added to the screen, the loyalty application 604 may proceed to the transaction summary screen 656. The transaction summary 656 may provide a listing of items and/or services 652 purchased and further provide the consumer 104 with the option 660 of validating the purchase with a stamp, QR code, or otherwise. Validation occurs when a stamp fingerprint is received, when a QR code is scanned and/or entered, and/or when another identifier is received at the communication device 108. If the consumer 104 selects the stamp and/or QR code validation option for example, the loyalty application 604 may proceed to a screen resembling FIG. 6E. If the consumer 104 selects the validate with stamp option, the loyalty application 604 may configure the communication device 108 such that the communication device 108 is ready to receive a stamp on the touchscreen 352 and perform a process as depicted in FIGS. 7A-7B. If the consumer 104 selects the QR code validation option, the loyalty application 604 may proceed to access a camera application such that a process as depicted in FIG. 9 can be performed.

As depicted in FIGS. 6E-6F, a validation screen 664 may prompt a user to show the screen to an authorized “validator,” such as a budtender, associate, or other person at a retailer, or otherwise, responsible for conducting transactions. The authorized validator may then provide the necessary identifier from a stamp, QR code, or other means. As depicted in FIG. 6F, once the identifier is received at the items 652 of the communication device 108, the communication device 108 may transmit the identifier to the client engagement and loyalty platform 132 and receive a response from the client engagement and loyalty platform 132 indicating that the validation was successful. Accordingly, a validation success notification message 668 may indicate that the transaction has been validated.

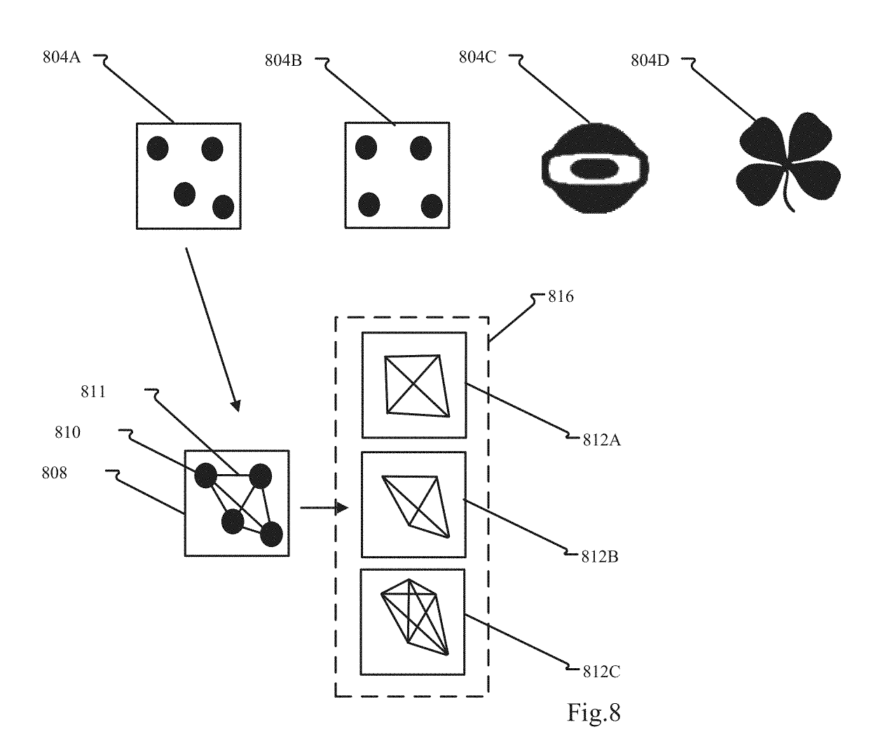

In accordance with embodiments of the present disclosure, FIGS. 7A-7B depict a stamping process 700 that may be used when a transaction is validated. As illustrated in FIG. 7A, a stamp 704 utilized during the validation process may be moved toward the communication device 108. As depicted in FIG. 7B, the stamp 704 is placed on the communication device 108 and may or may not contact the touchscreen 352 of the communication device 108. The stamp 704 may include one or more designs 804A-804D as depicted in FIG. 8. A design 808, for example, may be received at the touchscreen 352 of the communication device 108; one or more points 810 and lines 811 may be identified and/or calculated to uniquely identify the stamp 808. The stamp 808 may be associated with a particular associate profile within the retailer profile information 524. One or more stored stamp identifiers 812A-C may be compared to the design 808 received at the touchscreen 352 of the communication device 108. Accordingly, a match between the design 808 and a stored design 812B may indicate that a particular validator validated a transaction. Such validation may be added or otherwise included in the retailer profile(s) 520. As previously indicated, the one or more stored designs 812A-C may be stored in the validation store 816, which may be the same as or similar to the identification store 228 previously described. The stamps, 804A-804D for example, may be a small piece of plastic with secret digital identities. For example, the stamps may be the same as SnowShoe, having no batteries, power, circuitry, antenna, and moving parts. The stamps provide a physical factor of authentication for validation in a POS transactions. Stamps work with all multi-touch mobile devices, and their software can be integrated into a project in mere minutes. Additional information about the stamps can be found in the “2015-04-startup-digital-physical-worlds.html” document located at Startup marries digital, physical worlds (2015, Apr. 27) retrieved 28 Feb. 2017 from the website located at phys.org/news/. The 2015-04-startup-digital-physical-worlds.html document is herein incorporated by reference for all that it teaches and for all purposes. In some embodiments, receiving the identification information to identify a validator may further include determining whether the communication device 108 is in physical proximity to the validator using a geo-fencing process. That is, if the communication device 108 is not in physical proximity to the validator when such validation process occurs, the rewards, and/or points, may not be assigned to the consumer 104.

In accordance with embodiments of the present disclosure, FIG. 9 depicts a process 900 for retrieving a QR code that may be used when a transaction is validated. As illustrated in FIG. 9, an image of a QR image 904 utilized during the validation process may be acquired by the camera 336 of the communication device 108. Utilizing a QR reader, the QR image 904 may provide an identifier that is associated with a particular associate and/or validator profile within the retailer profile information 524. The identifier may indicate that a particular validator validated a transaction. Such validation may be added or otherwise included in the retailer profile(s) 520.

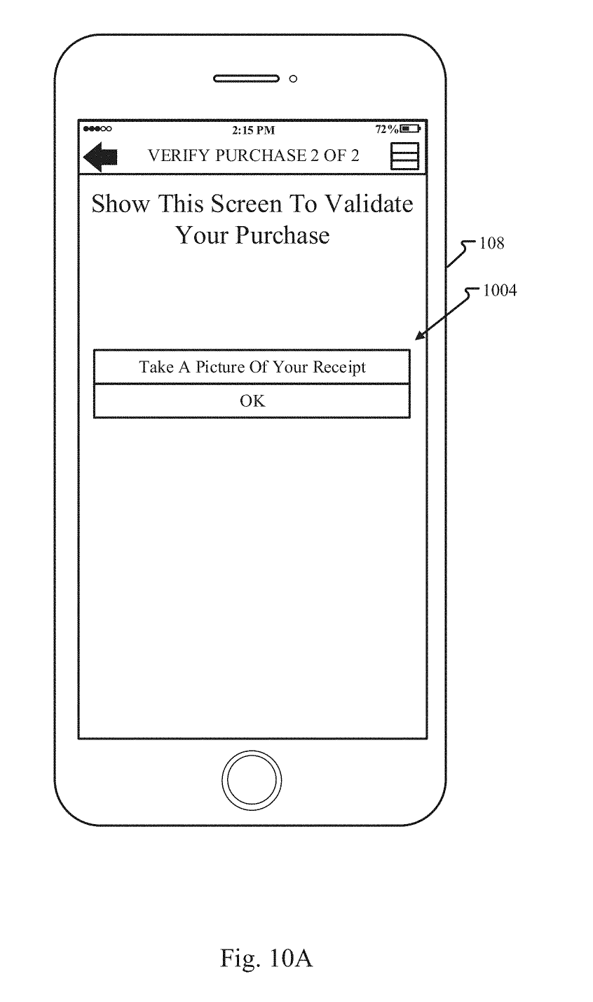

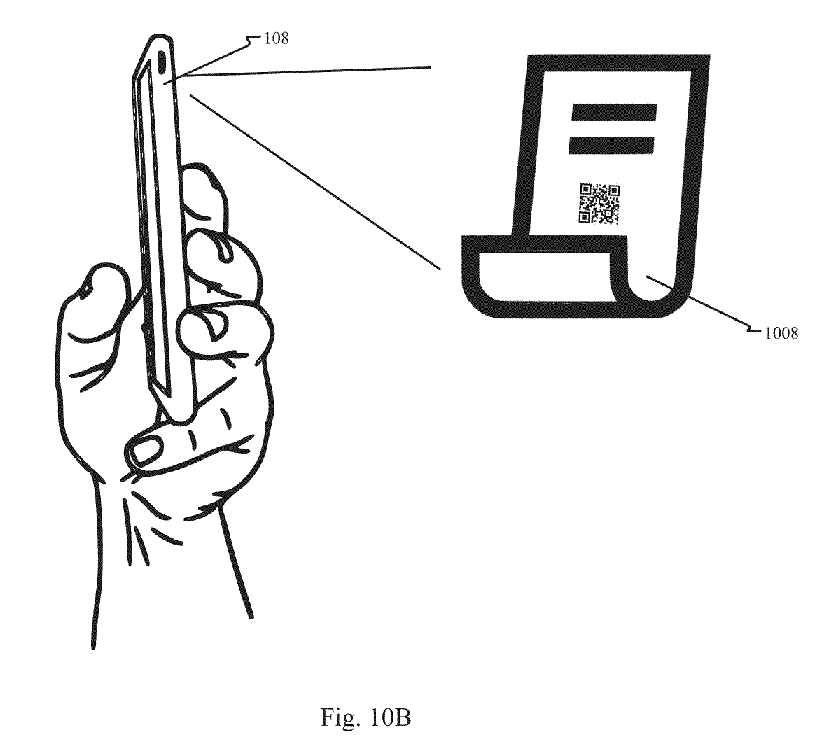

In some instances, the transaction may be validated and a validation success notification message 668 may be displayed as in FIG. 6F. In other instances, the transaction may need to be verified. That is, although the retailer may validate a transaction, merely entering items and validating such items may leave the manufacturer, distributer, and/or wholesaler up for being gamed by an associate, validator, and/or other individual with nefarious intent. That is, a user, in theory, could add items to the validation screen to receive a large reward amount, and then find a validator to validate the transaction. In that no actual purchase is needed in order to receive the reward or be awarded the points, one could obtain a large amount of rewards. Therefore, in some instances, a consumer 104 may be prompted by a verification screen 1004 of the loyalty application 604, as depicted in FIG. 10A, to take a picture of their receipt 1004 using the camera 336 of the communication device 108 and upload such picture to the client engagement and loyalty platform 132 using the loyalty application 604. Thus, prior to any reward and/or points being award to a consumer profile(s) 508; such items in the transaction summary may be compared to items on one or more receipts. If such items match, then the consumer 104 may receive such rewards. That is, as depicted in FIGS. 10A and 10B, to reduce the likelihood and/or prevent users from gaming the loyalty platform, after validating a transaction, the consumer may be prompted to take a photo of their receipt 1004. The receipt 1004 may then be automatically uploaded to the client engagement and loyalty platform 132 by the loyalty application 604. The loyalty application 604 may then reconcile the receipt 1004 with the products purchased and/or validated. In accordance with embodiments of the present disclosure, a consumer may be presented with the need to take a picture of their receipt 1004 randomly. That is, not every validated transaction may be verified. The reward points may then be provided to a user's account. For example, the rewards points totaled in the screen in FIG. 6D may be associated with a user account and/or profile of the user/consumer.

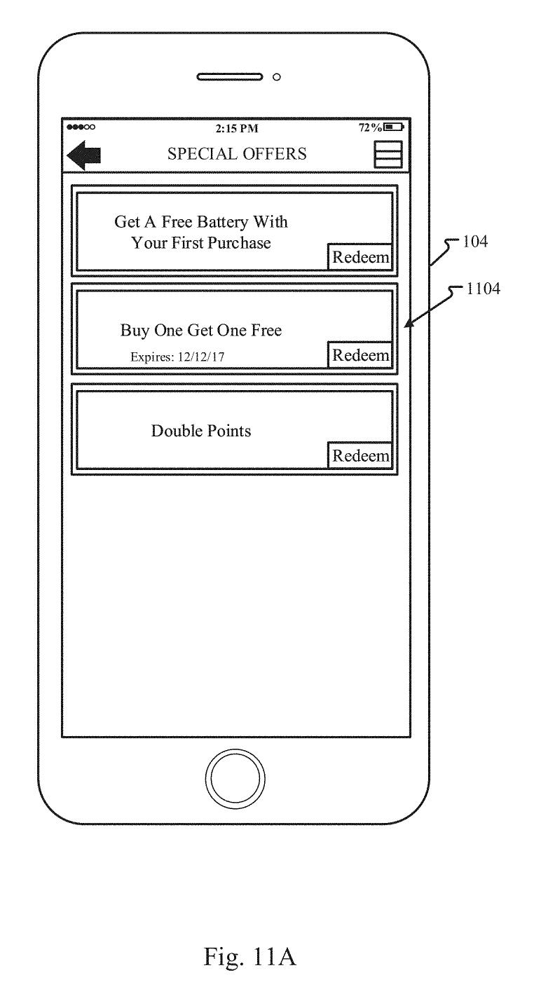

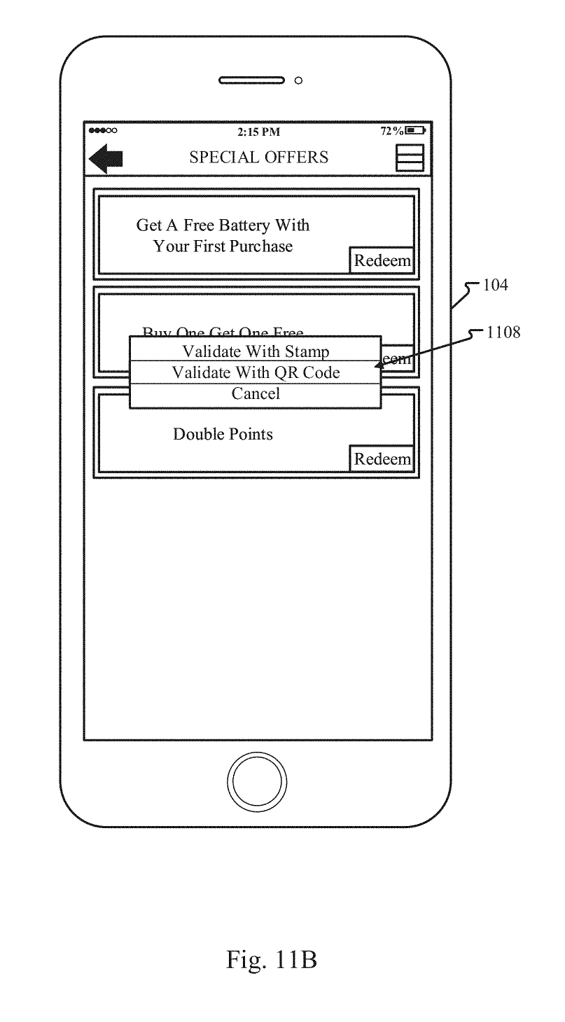

As depicted in FIGS. 11A-B, a “Special Offers” screen 1104 may be displayed to a consumer 104. The “Special Offers” screen 1104 may depict one or more items redeemable with rewards points. Similar to a transaction validation for earning rewards points, the transaction associated with burning rewards points may be same. That is, the consumer wishing to acquire merchandise with the rewards points may be prompted with the validation screen 1108 and may need to receive an identifier from an authorized “validator” as previously described. The identifier may be received from a stamp, QR code, or other means. Alternatively, or in addition, the purchase of redeeming points may be similar to or the same as the screen or display presented to a consumer 104 in FIGS. 11A-11B.

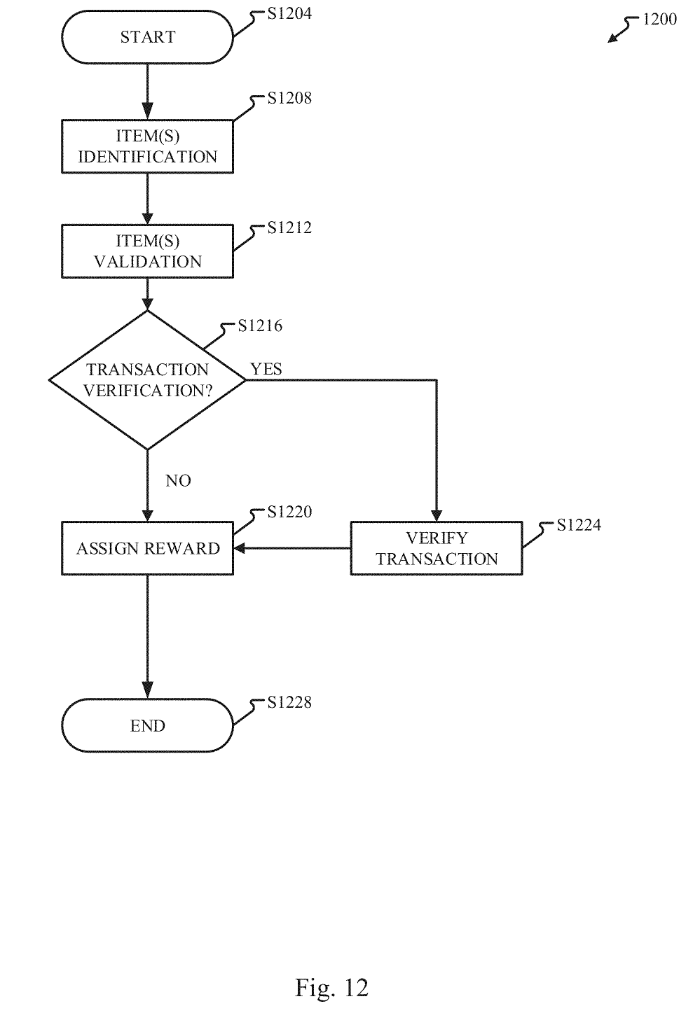

Referring now to FIG. 12, a flow diagram of a method 1200 for earning rewards utilizing the client engagement and loyalty platform 132 is shown in accordance with embodiments of the present disclosure. While a general order for the steps of the method 1200 is shown in FIG. 12, the method 1200 can include more or fewer steps or can arrange the order of the steps differently than those shown in FIG. 12. Generally, the method 1200 starts with a start operation S1204 and ends with an end operation S1228. The method 1200 can be executed as a set of computer-executable instructions executed by a computer system and encoded or stored on a computer-readable medium. Hereinafter, the method 1200 shall be explained with reference to the systems, components, assemblies, devices, user interfaces, environments, software, etc. described in conjunction with FIGS. 1-11.

The method 1200 begins at step S1204 wherein a consumer 104 may enter one or more items 652 into a screen or display of a loyalty application 604 as depicted in FIG. 6C and in accordance with step S1208. The items may be physical items, participation and/or event descriptors, services, and/or other discernable information having a reward value. An item summary and number of reward points may then be displayed to a screen or display of the loyalty application 604, such as the screen or display depicted in FIG. 6D. The items may then be validated in a validation operation at step S1212. Randomly, or at a predetermined and/or known interval, the transaction may be verified; accordingly, if it is determined that the transaction is to be verified at step S1216, the method 1200 proceeds to step S1224 where the transaction is verified. Following verification at step S1216 and/or if it is determined that the transaction does not need to be verified, the method 1200 proceeds to step S1220. Once the rewards are assigned to a profile, for example a consumer(s) profile 236, retailer(s) profile 240, wholesaler(s) profile 244, and/or distributor(s) profile 248, the method 1200 then ends at step S1228.

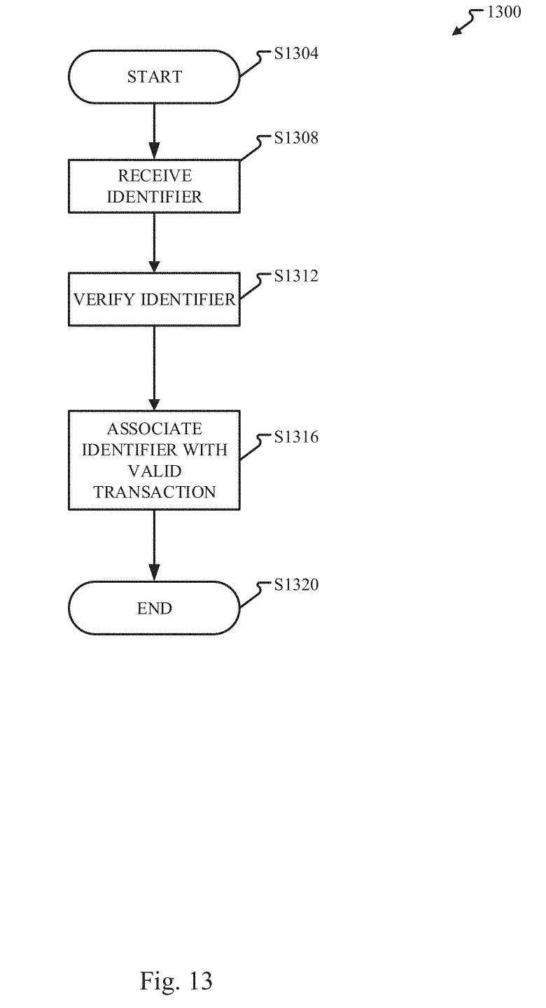

Referring now to FIG. 13, a flow diagram of a method 1300 for validation of a transaction using a client engagement and loyalty platform 132 is shown in accordance with embodiments of the present disclosure. While a general order for the steps of the method 1300 is shown in FIG. 13, the method 1300 can include more or fewer steps or can arrange the order of the steps differently than those shown in FIG. 13. Generally, the method 1300 starts with a start operation S1304 and ends with an end operation S1320. The method 1300 can be executed as a set of computer-executable instructions executed by a computer system and encoded or stored on a computer-readable medium. Hereinafter, the method 1300 shall be explained with reference to the systems, components, assemblies, devices, user interfaces, environments, software, etc. described in conjunction with FIGS. 1-12.

The method 1300 begins at step S1304 wherein an identifier may be provided to the communication device 108. That is, as previously described, a stamp image 808 may be received at the touchscreen 352 of the communication device 108. Alternatively, or in addition, a QR code may be received via an image of a QR image using a camera 336 of the communication device 108. Thus, the identifier may be received at step S1308. The identifier may be verified at step S1312 by matching the identifier to an identification in an identification store 228 as previously described. If the identifier is an identifier of legitimate validator, the identifier may be associated with a valid transaction at step S1316. For example, the validated transaction may be added to one or more profiles as previously discussed. Method 1300 may then end at step S1320.

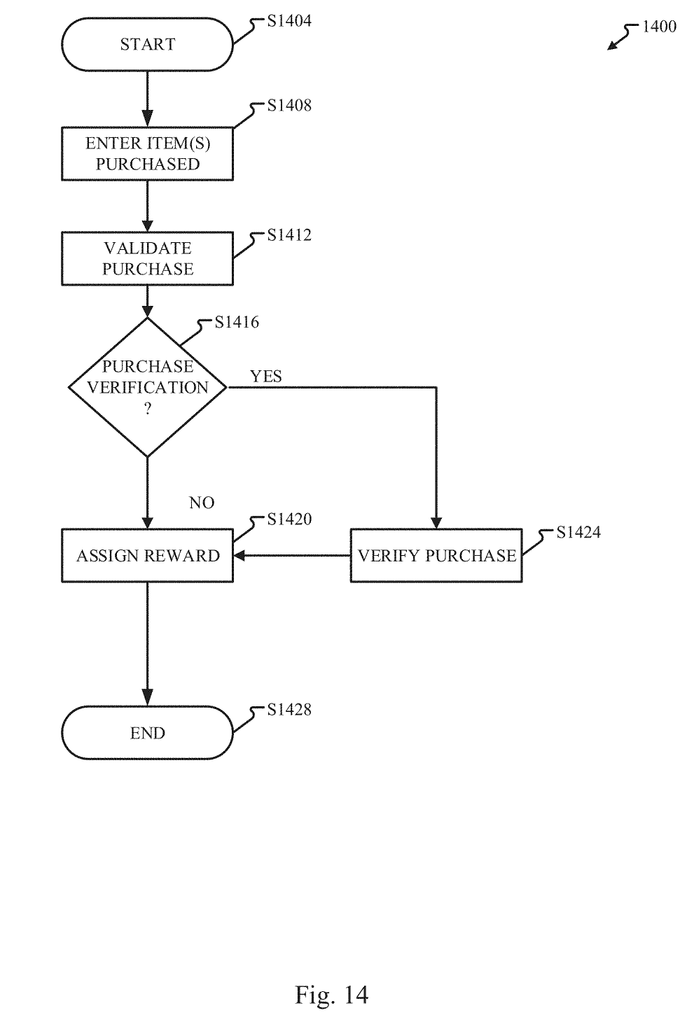

Referring now to FIG. 14, a flow diagram of a method 1400 for earning rewards utilizing the client engagement and loyalty platform 132 is shown in accordance with embodiments of the present disclosure. While a general order for the steps of the method 1400 is shown in FIG. 14, the method 1400 can include more or fewer steps or can arrange the order of the steps differently than those shown in FIG. 14. Generally, the method 1400 starts with a start operation S1404 and ends with an end operation S1428. The method 1400 can be executed as a set of computer-executable instructions executed by a computer system and encoded or stored on a computer-readable medium. Hereinafter, the method 1400 shall be explained with reference to the systems, components, assemblies, devices, user interfaces, environments, software, etc. described in conjunction with FIGS. 1-13.

The method 1400 begins at step S1404 wherein a consumer 104 may enter one or more purchased and/or redeemed items 652 into a screen or display of a loyalty application 604 as depicted in FIG. 6C and in accordance with step S1408. A purchased item summary and number of reward points either earned or burned may then be displayed to a screen or display of the loyalty application 604, such as the screen or display depicted in FIG. 6D. The purchased and/or redeemed items may then be validated in a validation operation at step S1412. Randomly, or at a predetermined and/or known interval, the purchase and/or redemption transaction may be verified; accordingly, if it is determined that the purchase and/or redemption transaction is to be verified at step S1416, the method 1400 proceeds to step S1424 where the purchase and/or redemption transaction is verified. Following purchase and/or redemption verification at step S1416 and/or if it is determined that the purchase and/or redemption transaction does not need to be verified, the method 1400 proceeds to step S1420. Once the rewards are assigned to or removed from a profile, for example a consumer(s) profile 236, retailer(s) profile 240, wholesaler(s) profile 244, and/or distributor(s) profile 248, the method 1400 then ends at step S1428.

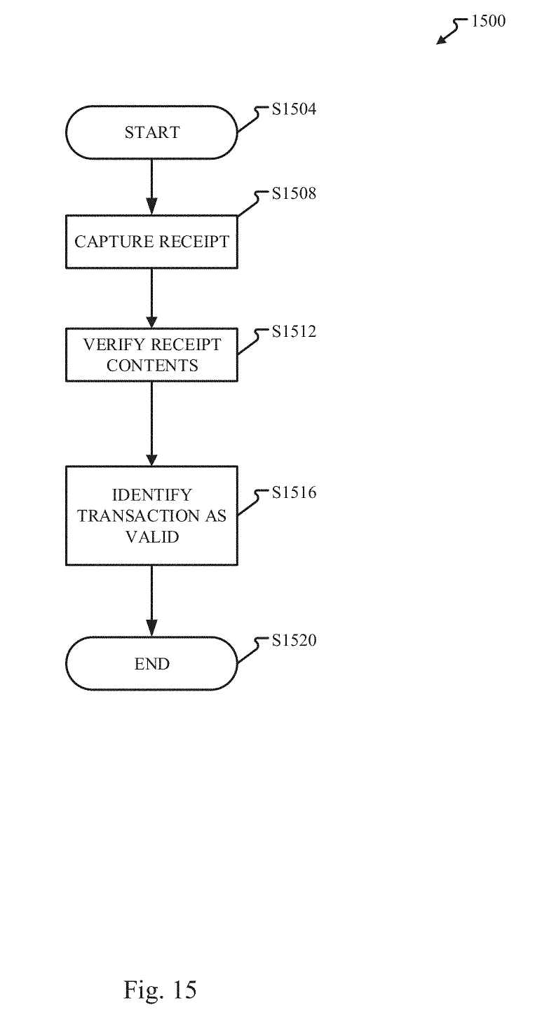

Referring now to FIG. 15, a flow diagram of a method 1500 for verifying a transaction using a client engagement and loyalty platform 132 is shown in accordance with embodiments of the present disclosure. While a general order for the steps of the method 1500 is shown in FIG. 15, the method 1500 can include more or fewer steps or can arrange the order of the steps differently than those shown in FIG. 15. Generally, the method 1500 starts with a start operation S1504 and ends with an end operation S1520. The method 1500 can be executed as a set of computer-executable instructions executed by a computer system and encoded or stored on a computer-readable medium. Hereinafter, the method 1500 shall be explained with reference to the systems, components, assemblies, devices, user interfaces, environments, software, etc. described in conjunction with FIGS. 1-14.

The method 1500 begins at step S1504 wherein a verification transaction is commenced. The method 1500 may the proceed to step S1508 where an image of a receipt 1008 is captured. In most instance, the loyalty application 604 may invoke or otherwise access the camera 336 of the communication device 108 to take a photo or image of a receipt 1008. The contents of the receipt may then be compared with the purchased items entered in the method 1400 for example at step S1512. Prior to any comparison, an optical character recognition process may occur such that the items listed on the receipt may be compared to items entered in the method 1400. Alternatively, or in addition, the contents of the receipt may be obtained utilizing identification located on the receipt or otherwise associated with the receipt. For instance, a QR code, or matrix barcode, may be utilized to retrieve receipt contents. If the contents of the receipt match the contents of the purchased items entered in the method 1400, the method 1500 may then proceed to step S1516 where the transaction is identified as a valid and verified transaction. Such information may then be added to one or more profiles as previously discussed. Method 1500 may then end at step S1520.

The exemplary systems and methods of this disclosure have been described in relation to a client engagement and loyalty platform. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments of the client engagement and loyalty platform may include receiving, at a communication device, an order summary identifying a plurality of items, wherein the order summary is associated with a user account, receiving, at the communication device, identification information including one or more identifiers associated with a retail establishment, and associating, based on the one or more identifiers of the retail establishment and the order summary, a plurality of reward points with the user account.

Aspects of the above client engagement and loyalty platform may include where the identification information is received at a touchscreen of the communication device. Additional aspects of the above client engagement and loyalty platform may include where the identification information is associated with a stamp that is associated with the retail establishment. Further aspects of the above client engagement and loyalty platform may include where the retail establishment sells the plurality of purchased items identified in the order summary. Further yet, aspects of the above client engagement and loyalty platform may include associating a second plurality of reward points to an account associated with the retail establishment. Further still, aspects of the above client engagement and loyalty platform may include identifying a plurality of user accounts based on purchase history information associated with the retail establishment, and assembling an advertisement to be provided to the plurality of user accounts. Additional aspects of the above client engagement and loyalty platform may include identifying a plurality of user accounts based on purchase history information associated with the retail establishment, and assembling an advertisement to be provided to communication devices associated with the plurality of user accounts. Further still, aspects of the above client engagement and loyalty platform may include capturing, using a camera of the communication device, an image of a receipt, identifying items purchased and listed on the receipt, and determining whether the identified items listed on the receipt match the plurality of items in the order summary. Further yet, aspects of the above client engagement and loyalty platform may include capturing an image of a matrix barcode, wherein the identification information is associated with the matrix barcode.

Embodiments of the client engagement and loyalty platform may include a method comprising identifying a plurality of user accounts based on purchase history information in each of the user accounts that is associated with a retail establishment, wherein the purchase history information includes a specified item purchased at the retail establishment, generating an advertisement based on the specified item and the retail establishment, and providing the advertisement to one or more users associated with the plurality of user accounts.

Aspects of the above client engagement and loyalty platform may include providing the advertisement as a push notification to a communication device associated with a communication device that is associated with the one or more users. Additional aspects may include receiving, at a communication device, an order summary identifying a plurality of items, wherein the order summary is associated with a user account of the plurality of user accounts, validating the order summary, and associating, based on the order summary, a plurality of reward points with a user account associate with the retail establishment. Further yet, aspects of the above client engagement and loyalty platform may include associating, based on the order summary, a plurality of reward points with a user account of the plurality of user accounts. Additional aspects may include where the retail establishment sells the plurality of purchased items identified in the order summary. Further still, aspects of the above client engagement and loyalty platform may include reducing, based on the order summary, a plurality of reward points associated with a user account of the plurality of user accounts. Further yet, aspects may include a computer-readable medium including one or more processor executable instructions, which when executed by a processor, perform the above method(s).

Additional embodiments may include a client engagement and loyalty platform comprising a database including a consumer profile and a retail establishment profile, one or more instructions residing in a memory that, when executed by a processor of a communication device, cause the communication device to receive an order summary identifying a plurality of items, determine identification information including one or more identifiers associated with a retail establishment in the retail establishment profile, associate a first plurality of reward points with the consumer in the consumer profile, and associate a second plurality of reward points with the retail establishment in the retail establishment profile.

Aspects of the above client engagement and loyalty platform may include where the retail establishment sells the plurality of items identified in the order summary. Additional aspects of the above client engagement and loyalty platform may include wherein the one or more instructions residing in the memory further cause the communication device to capture, using a camera of the communication device, an image of a receipt, identify items purchased and listed on the receipt, and determine whether the identified items listed on the receipt match the plurality of items in the order summary. Further yet, aspects of the above client engagement and loyalty platform may include where the identification information is received at a touchscreen of the communication device.

Any one or more of the aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

In accordance with embodiments of the present disclosure, each of the consumer(s) profile 236 may be the same as or is otherwise associated with a consumer(s) account; retailer(s) profile 240 may be the same as or is otherwise associated with a retailer(s) account; wholesaler(s) profile 244 may be the same as or is otherwise associated with a wholesaler(s) account, distributor(s) profile 248 may be the same as or is otherwise associated with a distributor(s) account. Moreover, a retailer may the same as or is otherwise associated with a retail establishment.

The terms “determine,” “calculate,” “compute,” and variations thereof, as used herein, are used interchangeably and include any type of methodology, process, mathematical operation or technique.

What is claimed is:

1. A method comprising:
receiving, at a communication device, an order summary identifying a plurality of items, wherein the order summary is associated with a user account;
receiving, at the communication device, identification information information including one or more identifiers associated with a retail establishment; and
associating, based on the one or more identifiers of the retail establishment and the order summary, a plurality of reward points with the user account.

2. The method according to claim 1, wherein the identification information is received at a touchscreen of the communication device.

2. The method according to claim 2, wherein the identification information is associated with a stamp that is associated with the retail establishment.

4. The method according to claim 3, wherein the retail establishment sells the plurality of purchased items identified in the order summary.

5. The method according to claim 1, further comprising:
associating a second plurality of reward points to an account associated with the retail establishment.

6. The method according to claim 5, further comprising:
identifying a plurality of user accounts based on purchase history information associated with the retail establishment; and
assembling an advertisement to be provided to the plurality of user accounts.

7. The method according to claim 5, further comprising:
identifying a plurality of user accounts based on purchase history information associated with the retail establishment; and
assembling an advertisement to be provided to communication devices associated with the plurality of user accounts.

8. The method according to claim 1, further comprising:
capturing, using a camera of the communication device, an image of a receipt;
identifying items purchased and listed on the receipt; and
determining whether the identified items listed on the receipt match the plurality of items in the order summary.

9. The method according to claim 1, further comprising:
capturing an image of a matrix barcode, wherein the identification information is associated with the matrix barcode.

10. A method comprising:
identifying a plurality of user accounts based on purchase history information in each of the user accounts that is associated with a retail establishment, wherein the purchase history information includes a specified item purchased at the retail establishment;
generating an advertisement based on the specified item and the retail establishment; and
providing the advertisement to one or more users associated with the plurality of user accounts.

11. The method of claim 10, further comprising:
providing the advertisement as a push notification to a communication device associated with a communication device that is associated with the one or more users.

12. The method of claim 10, further comprising:
receiving, at a communication device, an order summary identifying a plurality of items, wherein the order summary is associated with a user account of the plurality of user accounts;
validating the order summary; and
associating, based on the order summary, a plurality of reward points with a user account associate with the retail establishment.

13. The method of claim 12, further comprising:
associating, based on the order summary, a plurality of reward points with a user account of the plurality of user accounts.

14. The method of claim 13, wherein the retail establishment sells the plurality of purchased items identified in the order summary.

15. The method of claim 12, further comprising:
reducing, based on the order summary, a plurality of reward points associated with a user account of the plurality of user accounts.

16. A computer-readable medium comprising one or more processor executable instructions, which when executed by a processor, perform the method of claim 10.

17. A client engagement and loyalty platform comprising:
a database including a consumer profile and a retail establishment profile;
one or more instructions residing in a memory that, when executed by a processor of a communication device, cause the communication device to:
receive an order summary identifying a plurality of items,
determine identification information including one or more identifiers associated with a retail establishment in the retail establishment profile,
associate a first plurality of reward points with the consumer in the consumer profile, and
associate a second plurality of reward points with the retail establishment in the retail establishment profile.

18. The client engagement and loyalty platform of claim 17, wherein the retail establishment sells the plurality of items identified in the order summary.

19. The client engagement and loyalty platform of claim 18, wherein the one or more instructions residing in the memory further cause the communication device to:
capture, using a camera of the communication device, an image of a receipt;
identify items purchased and listed on the receipt; and
determine whether the identified items listed on the receipt match the plurality of items in the order summary.

20. The client engagement and loyalty platform of claim 17, wherein the identification information is received at a touchscreen of the communication device.
